(19) United States
(12) Patent Application Publication
(10) Pub. No.: US 2018/0098904 A1
(43) Pub. Date: Apr. 12, 2018

(54) MASSAGING DEVICE

(71) Applicant: Paul CHEN, Vancouver (CA)

(72) Inventor: Paul CHEN, Vancouver (CA)

(21) Appl. No.: 15/291,098

(22) Filed: Oct. 12, 2016

(51) Int. Cl. A61H 1/00; A61H 15/00

(52) U.S. Cl. CPC A61H 1/008; A61H 15/0092

(57) ABSTRACT

A massaging device includes a shaft having two end portions, a handlebar attached to the shaft and perpendicular to the shaft, and a massaging member attached to the shaft. The massaging member is attached to either of the end portions of the shaft. The handlebar includes one end portion attached to the middle portion of the shaft and perpendicular to the shaft for forming a T-shaped structure. The massaging member is attached to the shaft with a fastener. A massaging element is attached to the shaft and includes a barrel having a space for engaging with the shaft. The massaging member includes a cylindrical ember having one or more spring biased latches engaged with the massaging element.

### BACKGROUND OF THE INVENTION

### 1. Field of the Invention

The present invention relates to a massaging device, and more particularly to a massaging device including an improved and simplified structure or configuration that may be easily and quickly made or manufactured or assembled by the workers and including an adjustable structure or configuration for adjusting the arrangement of the massaging members and for adjusting the massaging effects to the users.

### 2. Description of the Prior Art

Typical massaging devices comprise a relatively harder or stronger inner housing, and a relatively softer or resilient outer layer for selectively contacting or engaging with the users and for massaging purposes.

For example, U.S. Pat. No. 4,807,603 to Yasui discloses one of the typical massaging devices also comprising a relatively harder or stronger inner housing having a cylindrical shape, and a relatively softer or resilient outer layer for selectively contacting or engaging with the users and for massaging purposes.

However, the outer layer includes a smooth outer peripheral structure or contour that may not be frictionally contacted or engaged with the users such that the users may not be massaged with the typical massaging devices.

U.S. Pat. No. 8,888,808 to Park discloses another typical massaging device comprising a planar base member having a number of projections or protrusions extended outwardly therefrom for frictionally contacting or engaging with the users and for massaging purposes.

However, the projections or protrusions extended outwardly from the planar base member, but may not be adjusted relative to the planar base member, and thus may not provide different massaging forces or effects to the users.

The present invention has arisen to mitigate and/or obviate the afore-described disadvantages of the conventional massaging devices.

### SUMMARY OF THE INVENTION

The primary objective of the present invention is to provide a massaging device including an improved and simplified structure or configuration that may be easily and quickly made or manufactured or assembled by the workers.

The other objective of the present invention is to provide a massaging device including an adjustable structure or configuration for adjusting the arrangement and/or the position of the massaging members and for adjusting the massaging effects to the users.

In accordance with one aspect of the invention, there is provided a massaging device comprising a first shaft including two end portions and a middle portion, a handlebar attached to the first shaft and perpendicular to the first shaft, and a massaging member attached to the first shaft for allowing the massaging member and the first shaft to be moved to engage with and to massage the user with the handlebar.

The massaging member is attached to either of the end portions of the first shaft. The handlebar includes a first end portion attached to the middle portion of the first shaft and perpendicular to the first shaft for forming a T-shaped structure. The massaging member is attached to the first shaft with at least one fastener and moved in concert with the first shaft.

A massaging element may further be provided and attached to the first shaft and moved in concert with the first shaft. The massaging element includes a barrel having a space formed therein for receiving and engaging with the first shaft. The massaging element includes an engaging member formed in the barrel, and the massaging member includes a cylindrical member engaged with the first shaft and having at least one spring biased latch engaged with the engaging member of the massaging element.

The massaging element includes a tubular member extended therefrom and engaged into a chamber of the first shaft. The first shaft includes at least one channel formed therein and communicating with the chamber of the first shaft, and the tubular member of the massaging element includes at least one rib extended outwardly therefrom for engaging with the channel of the first shaft and for guiding the tubular member of the massaging element to move relative to the first shaft.

A shank may further be provided and movably engaged with the handlebar and movable relative to the handlebar. The handlebar includes a compartment formed therein for slidably receiving and engaging with the shank. The shank includes a helical groove formed therein, and the handlebar includes a guide pin slidably engaging with the helical groove of the shank.

The shank includes a second shaft attached to the shank. The second shaft includes a second massaging member attached to the second shaft. A massaging element may further be provided and attached to the second shaft.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a massaging device in accordance with the present invention, as seen from the upper portion of the massaging device;

FIG. 2 is another partial exploded view as seen from the bottom portion of the massaging device;

FIG. 3 is a perspective view of the massaging device, illustrating the operation of the massaging device;

FIGS. 4, 5 are other perspective views similar to FIG. 3, illustrating the operation of the massaging device in the folding operation;

FIG. 6 is a side plan schematic view of the massaging device;

FIG. 7 is a cross sectional view of the massaging device, taken along lines 7-7 of FIG. 3; and

FIG. 8 is a further perspective view similar to FIGS. 3-5, illustrating the other arrangement of the massaging device.

### DETAILED DESCRIPTION OF THE PREFERRED EMBODIMENT

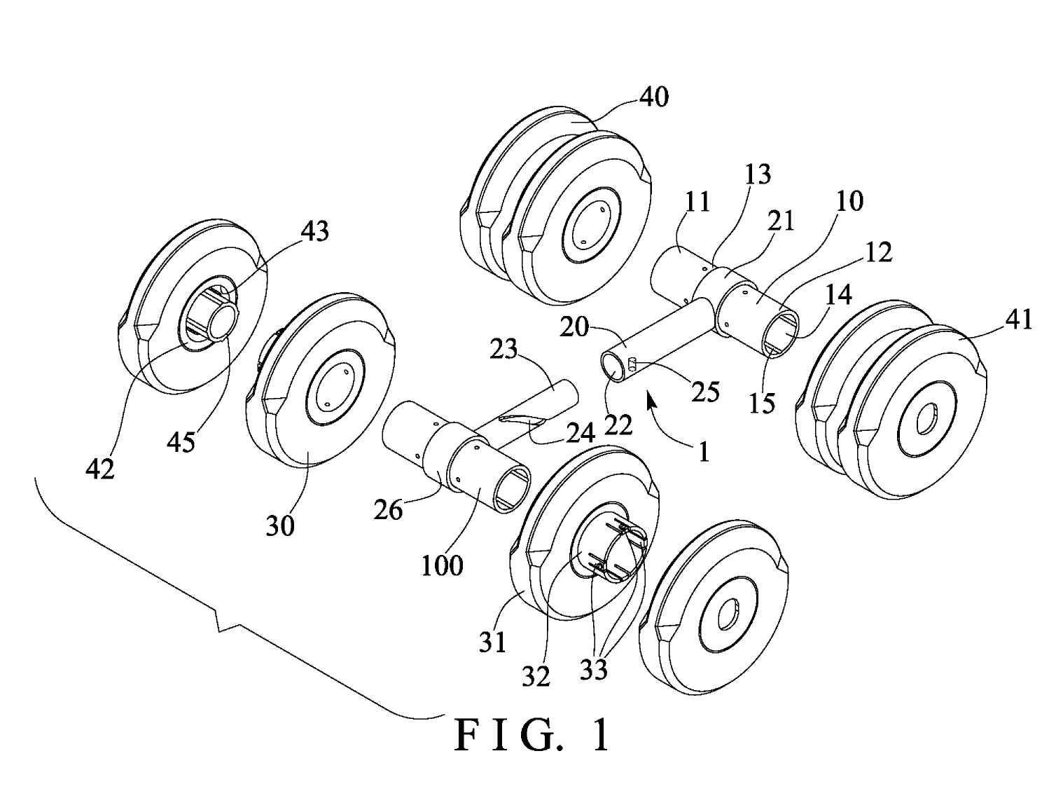

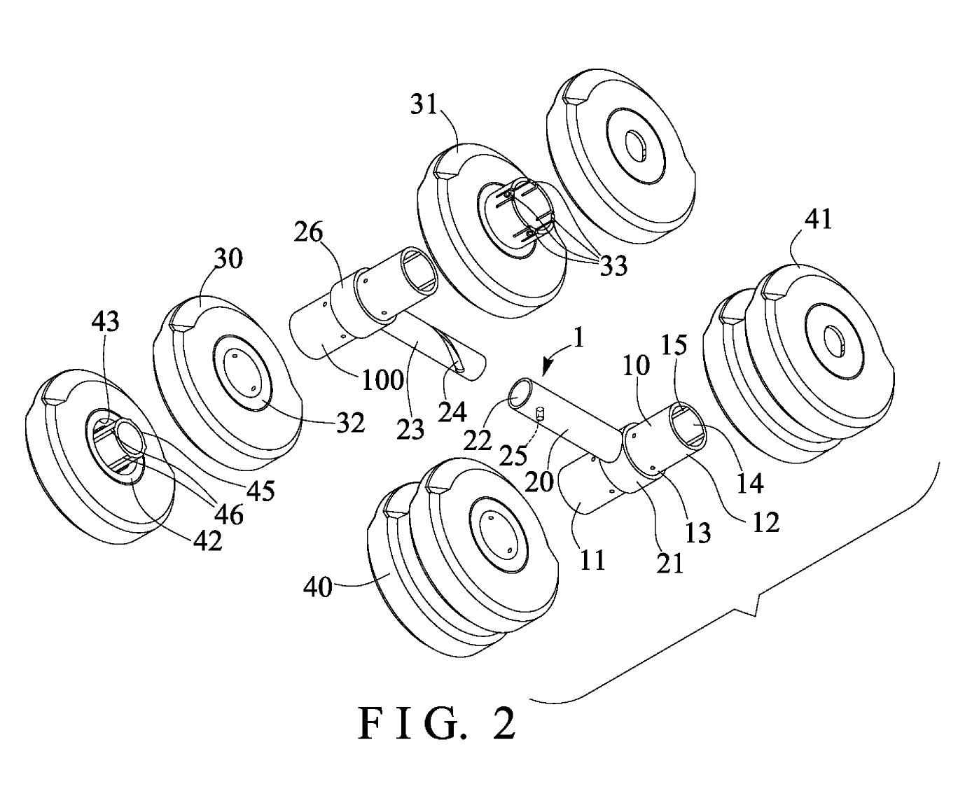

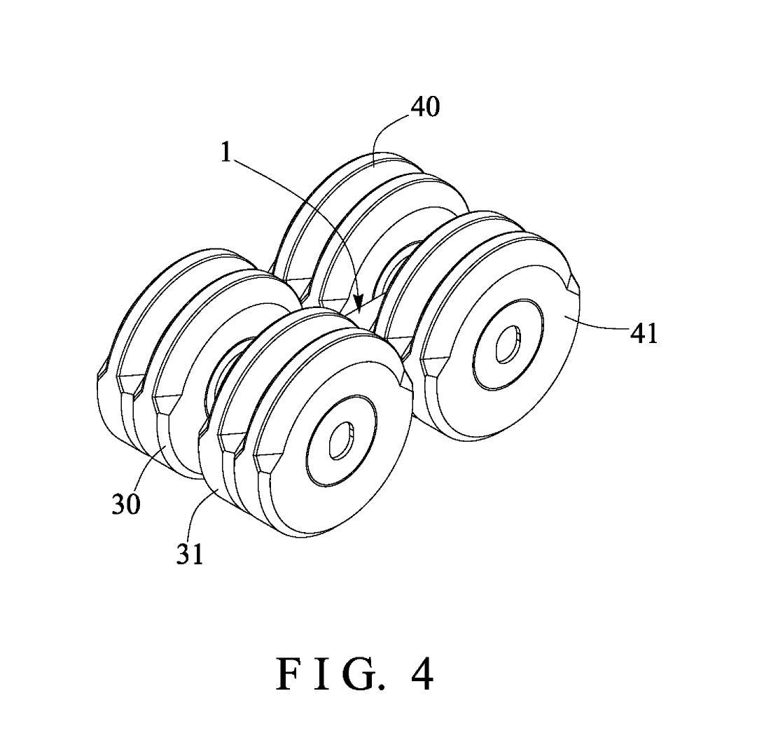

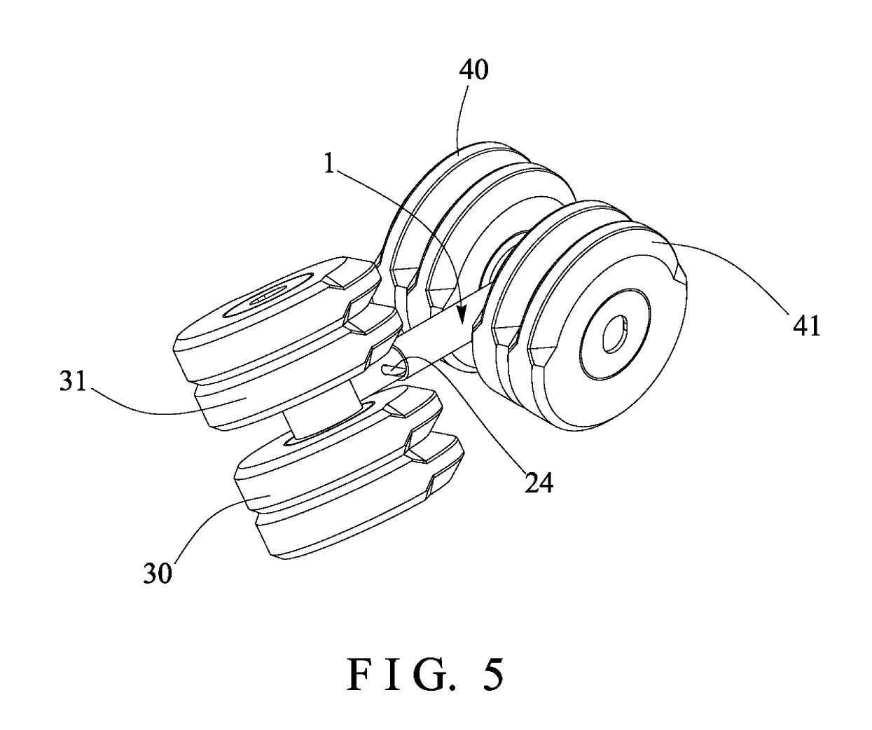

Referring to the drawings, and initially to FIGS. 1-6, a massaging device in accordance with the present invention comprises a handle device 1 including a first shank or shaft 10 having two end portions 11, 12, such as one or first end portion 11, another or second end portion 12 or the like, and a middle or intermediate portion 13, and including a handlebar 20 having one or first end portion 21 attached or mounted or secured to the middle portion 13 of the shaft 10 and perpendicular to the shaft 10 for forming or defining a substantially T-shaped structure or configuration, the shaft 10 includes a bore or inner compartment or chamber 14 formed therein (FIGS. 1-2, 5), and including one or more (such as four) elongated or longitudinal grooves or channels 15 formed therein and communicating with the chamber 14 of the shaft 10. The handlebar 20 includes a bore or inner chamber or compartment 22 formed therein.

The handle device 1 further includes an extension or shank 23 movably or slidably and optionally and selectively engaged into the compartment 22 of the handlebar 20 and movable or slidable or adjustable relative to the handlebar 20. For example, the shank 23 includes a spiral or helical groove 24 formed therein, and the handlebar 20 includes a guide pin 25 attached or mounted or secured therein and extended or engaged in the compartment 22 of the handlebar 20 and slidably engaged with the helical groove 24 of the shank 23 for guiding and limiting the shank 23 to pivot or rotate relative to the handlebar 20 when the shank 23 is moved or engaged into or out of the compartment 22 of the handlebar 20. The handle device 1 may further and optionally and selectively include another or second shaft 100 attached or mounted or secured to the one or first or free end portion 26 of the shank 23.

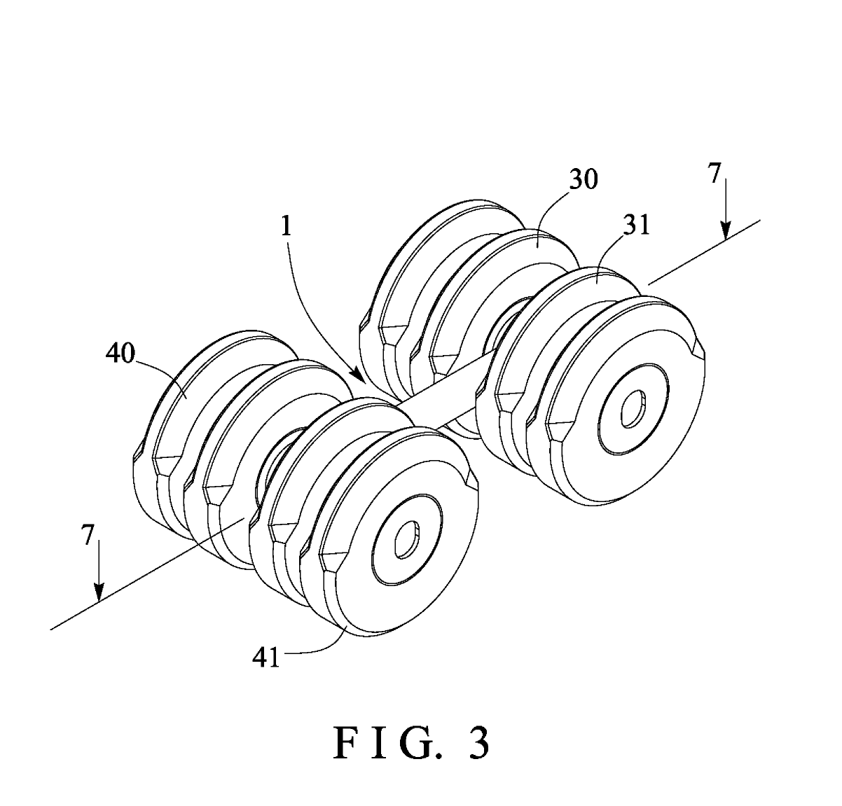

The second shaft 100 includes a structure or configuration similar or identical to that of the first shaft 10 and also includes two end portions 11, 12, such as one or first end portion 11, another or second end portion 12 or the like, and a middle or intermediate portion 13 attached or mounted or secured to the free end portion 26 of the shank 23 for forming or defining a substantially T-shaped structure or configuration, and the second shaft 100 also includes a bore or inner compartment or chamber 14 formed therein, and also includes one or more (such as four) elongated or longitudinal grooves or channels 15 formed therein and communicating with the chamber 14 of the second shaft 100. The second shaft 100 will also be pivoted or rotated, together with the shank 23, relative to the handlebar 20 and the first shaft 10 (FIGS. 3-5) when the shank 23 is moved or engaged into or out of the compartment 22 of the handlebar 20.

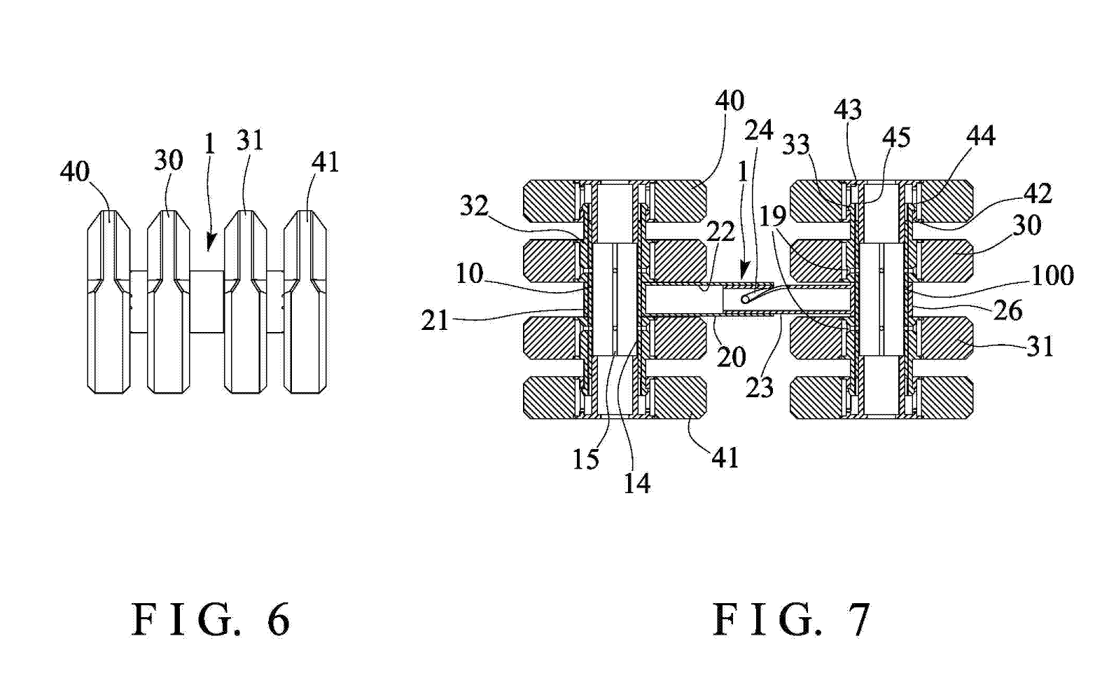

The massaging device in accordance with the present invention further comprises one or more (such as two) massaging members 30, 31 attached or mounted or secured to either or both of the end portions 11, 12 of either or both of the shafts 10, 100, with screws or bolts or catches or latches or fasteners 19 or the like (FIG. 7) for allowing the massaging member 30, 31 and the shaft 10, 100 to be moved to engage with and to massage the user with the handlebar 20. For example, the massaging members 30, 31 each include a hub or cylindrical member 32 attached or engaged with or onto the shaft 10, 100 and secured to the shaft 10, 100 with the fasteners 19, and each include one or more (such as four) spring biased blades or latches 33 formed or provided thereon. The massaging device in accordance with the present invention may further comprise one or more (such as two) massaging elements 40, 41 attached or mounted or secured to either or both of the end portions 11, 12 of either or both of the shafts 10, 100 and arranged or located close to or beside the massaging members 30, 31 respectively.

The massaging elements 40, 41 each include a cylindrical member or barrel 42 having a compartment or chamber or space 43 formed therein for receiving or engaging with the shaft 10, 100 and/or the cylindrical member 32 of the massaging member 30, 31 and each include one or more engaging notches or members 44 (FIG. 7) formed in the barrel 42 and communicating with the space 43 of the barrel 42 for engaging with the spring biased latches 33 and for detachably or removably attaching or mounting or securing the massaging element 40, 41 to the shaft 10, 100 and/or the massaging member 30, 31. The massaging elements 40, 41 each further include a hub or spindle or tubular member 45 extended outwardly therefrom and engaged into the chamber 14 of the shaft 10, 100 for anchoring or retaining or positioning the massaging element 40, 41 to the shaft 10, 100, and each further include one or more (such as four) elongated or longitudinal ridges or ribs 46 extended outwardly from the outer peripheral portion of the tubular member 45 for engaging with the channels 15 of the shaft 10, 100 and for guiding and limiting the tubular member 45 to move relative to the shaft 10, 100 and for preventing the tubular member 45 from pivoting or rotating relative to the shaft 10, 100.

In operation, as shown in FIGS. 3-5 and 7, the massaging members 30, 31 and the massaging elements 40, 41 that are provided on the second shaft 100 may be pivoted or rotated, together with the shank 23, relative to the handlebar 20 and the first shaft 10 when the shank 23 is moved or engaged into or out of the compartment 22 of the handlebar 20 for allowing the massaging members 30, 31 to be moved or positioned and located or adjusted or separated away from massaging elements 40, 41 and for providing different massaging effect.

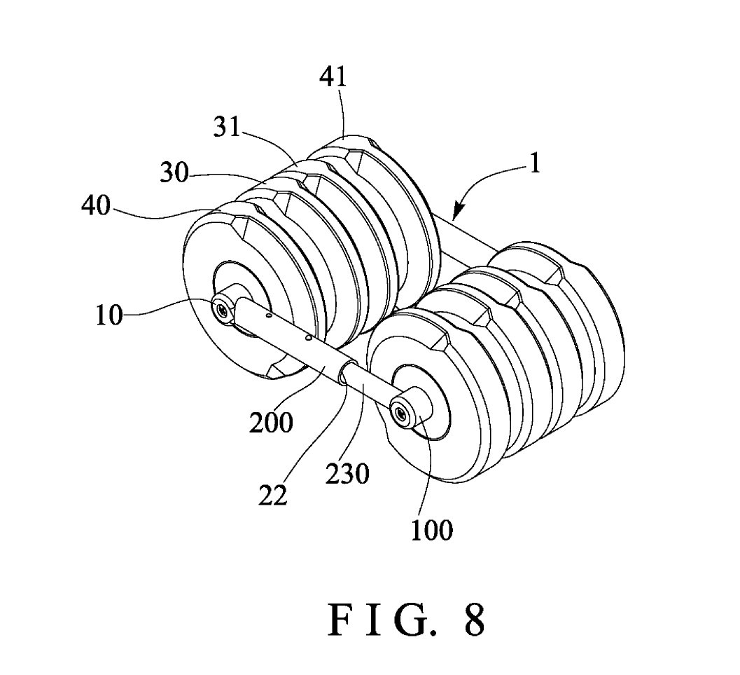

Alternatively, as shown in FIG. 8, the handle device 1 may include one or more (such as two) handlebars 200 attached or mounted or secured to one of the shafts 10, and one or more (such as two) shanks 230 movably or slidably and optionally and selectively engaged into the compartment 22 of the handlebars 200 and movable or slidable or adjustable relative to the handlebars 200, and attached or mounted or secured to the other shaft 100 for forming or defining the other shape or structure or configuration and for providing different massaging effect.

Accordingly, the massaging device in accordance with the present invention includes an improved and simplified structure or configuration that may be easily manufactured or assembled by the workers, and includes an adjustable structure or configuration for adjusting the arrangement or the position of the massaging members and for adjusting the massaging effects to the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A massaging device comprising:
a first shaft including two end portions and a middle portion,
a handlebar attached to said first shaft and perpendicular to said first shaft, and
a massaging member attached to said first shaft.

2. The massaging device as claimed in claim 1, wherein said massaging member is attached to either of said end portions of said first shaft.

3. The massaging device as claimed in claim 1, wherein said handlebar includes a first end portion attached to said middle portion of said first shaft and perpendicular to said first shaft for forming a T-shaped structure.

4. The massaging device as claimed in claim 1, wherein said massaging member is attached to said first shaft with at least one fastener.

5. The massaging device as claimed in claim 1 further comprising a massaging element attached to said first shaft.

6. The massaging device as claimed in claim 5, wherein said massaging element includes a barrel having a space formed therein for receiving and engaging with said first shaft.

7. The massaging device as claimed in claim 6, wherein said massaging element includes an engaging member formed in said barrel, and said massaging member includes a cylindrical member engaged with said first shaft and having at least one spring biased latch engaged with said engaging member of said massaging element.

8. The massaging device as claimed in claim 5, wherein said massaging element includes a tubular member extended therefrom and engaged into a chamber of said first shaft.

9. The massaging device as claimed in claim 8, wherein said first shaft includes at least one channel formed therein and communicating with said chamber of said first shaft, and said tubular member of said massaging element includes at least one rib extended outwardly therefrom for engaging with said at least one channel of said first shaft.

10. The massaging device as claimed in claim 1 further comprising a shank movably engaged with said handlebar and movable relative to said handlebar.

11. The massaging device as claimed in claim 10, wherein said handlebar includes a compartment formed therein for slidably receiving and engaging with said shank.

12. The massaging device as claimed in claim 10, wherein said shank includes a helical groove formed therein, and said handlebar includes a guide pin slidably engaging with said helical groove of said shank.

13. The massaging device as claimed in claim 10, wherein said shank includes a second shaft attached to said shank.

14. The massaging device as claimed in claim 13, wherein said second shaft includes a second massaging member attached to said second shaft.

15. The massaging device as claimed in claim 14 further comprising a massaging element attached to said second shaft.
